(19) United States
(12) Patent Application Publication
(10) Pub. No.: US 2017/0357267 A1
(43) Pub. Date: Dec. 14, 2017

(54) AUTONOMOUS WORK VEHICLE OBSTACLE DETECTION SYSTEM

(71) Applicants: CNH Industrial America LLC, New Holland, PA (US); Autonomous Solutions, Inc., Mendon, UT (US)

(72) Inventors: Christopher Alan Foster, Mohnton, PA (US); Bonoit Debide, Brugge (BE); Brad Abram Baillio, Smithfield, UT (US); Taylor Chad Bybee, Logan, UT (US)

(21) Appl. No.: 15/178,805

(22) Filed: Jun. 10, 2016

(51) Int. Cl. G05D 1/02; G05D 1/00

(52) U.S. Cl. CPC G05D 1/0219; G05D 1/0088

(57) ABSTRACT

A work vehicle includes at least one sensor configured to detect at least one property of a work area. The work vehicle includes a controller comprising a processor operatively coupled to a memory, wherein the controller is configured to receive a first signal from an at least one sensor indicative of the at least one property of the work area, to determine whether an obstacle occupies one or more locations of the work area by creating or updating a map having one or more cells that correspond to the one or more locations of the work area, wherein each of the one or more cells indicate whether the obstacle occupies the respective locations of the work area based on the at least one property, and to send a second signal based on the map.

### BACKGROUND

The invention relates generally to agricultural operations and, more specifically, to an obstacle detection system for an autonomous work vehicle.

Certain work vehicles, such as tractors or other prime movers, may be controlled by a control system (e.g., without operator input, with limited operator input, etc.) during certain phases of operation. For example, a controller may instruct a steering control system and/or a speed control system of the vehicle to automatically or semi-automatically guide the vehicle along a guidance swath within a field or other work area. However, the vehicle may encounter an obstacle during the operation.

### BRIEF DESCRIPTION

In a first embodiment, a work vehicle includes at least one sensor configured to detect at least one property of a work area, and a controller comprising a processor operatively coupled to a memory, wherein the controller is configured to receive a first signal from an at least one sensor indicative of the at least one property of the work area, to determine whether an obstacle occupies one or more locations of the work area by creating or updating a map having one or more cells that correspond to the one or more locations of the work area, wherein each of the one or more cells indicate whether the obstacle occupies the respective locations of the work area based on the at least one property, and to send a second signal based on the map.

In a second embodiment, a work vehicle includes a lidar sensor, and a controller comprising a processor and a memory, wherein the controller is configured to receive a first signal from the lidar sensor indicating distances and directions to an obstacle in a work area, to create or update a point cloud having a set of points based on the distance and directions, to create or update a map of one or more cells that correspond to one or more locations of the work area, wherein each of the one or more cells indicate whether the obstacle occupies the respective locations of the work area based on the points of the point cloud, to send a second signal indicative of the map to a control system of the vehicle.

In a third embodiment, a control system for a work vehicle includes a controller comprising a processor and a memory, wherein the memory is operatively coupled to the processor, wherein the processor is configured to receive a first signal from a first sensor indicating distances and directions to an obstacle in the agricultural field, to create or update a map of one or more cells that correspond to one or more locations of the agricultural field, wherein each of the one or more cells indicate whether the obstacle occupies the respective locations of the agricultural field, and to send a second signal indicative of instructions to control the vehicle based on the map.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a work vehicle that includes an obstacle detection system having one or more sensors;

FIG. 2 is a schematic diagram of an embodiment of the obstacle detection system that may be employed within the vehicle of FIG. 1;

FIG. 3 is a flow diagram of an embodiment of a method performed by the obstacle detection system of FIG. 1;

FIG. 4 is a flow diagram of an embodiment of a method performed by the obstacle detection system of FIG. 1;

FIG. 5A is a graph of an embodiment of data received by the obstacle detection system of FIG. 2 having the sensors directed in a first direction;

FIG. 5B is a graph of an embodiment of data received by the obstacle detection system of FIG. 2 having the one or more sensors in a second direction.

### DETAILED DESCRIPTION

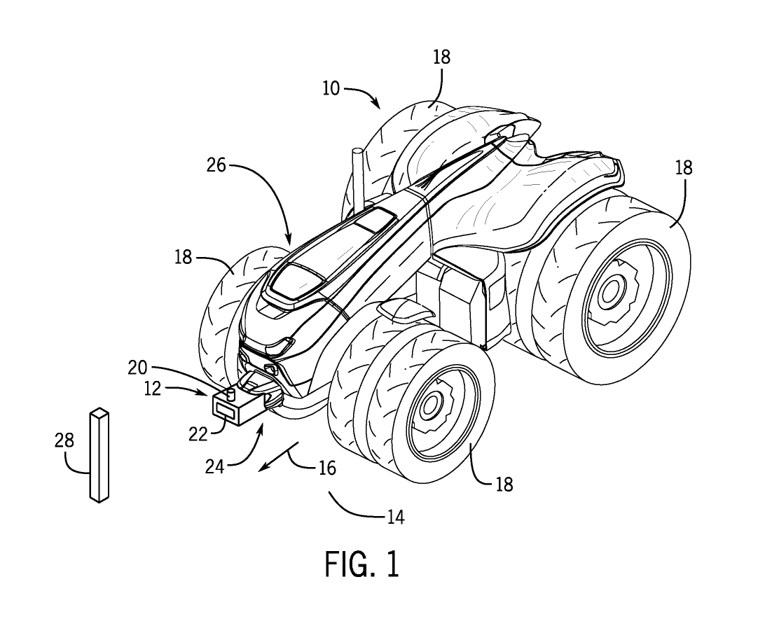

Turning now to the drawings, FIG. 1 is a perspective view of an embodiment of an autonomous work vehicle 10, such as a tractor, that may include an obstacle detection system 12. The autonomous vehicle 10 may include a control system configured to automatically guide the agricultural vehicle 10 through a work area, such as an agricultural field 14 (e.g., along a direction of travel 16) to facilitate operations (e.g., planting operations, seeding operations, application operations, tillage operations, harvesting operations, etc.). For example, the control system may automatically guide the vehicle 10 along a guidance path through the field 14 without input from an operator.

It should be noted that the techniques disclosed may be used on any desired type of vehicle, but are particularly useful for off-road and work vehicles. More particularly, one presently contemplated application is in the area of agricultural work operations, such as on farms, in fields, in operations entailed in preparing, cultivating, harvesting and working plants and fields, and so forth. While in the present disclosure reference may be made to the vehicle 10 as an “agricultural vehicle”, it should be borne in mind that this is only one particular area of applicability of the technology, and the disclosure should not be understood as limiting it to such applications.

To facilitate control of the autonomous agricultural vehicle 10, the control system includes a spatial locating device, such as a Global Position System (GPS) receiver which is configured to output position information to a controller of the control system. The spatial locating device is configured to determine the position and/or orientation of the autonomous agricultural vehicle based on the spatial locating signals. The autonomous agricultural vehicle 10 may include one or more wheels 18 to facilitate movement of the autonomous agricultural vehicle 10. Further, the autonomous agricultural vehicle 10 may be coupled to an agricultural implement to perform the agricultural operations. While the autonomous agricultural vehicle 10 is described in detail below, the autonomous agricultural vehicle may be any vehicle suitable for agricultural operations.

The obstacle detection system 12 may include one or more sensors to detect properties of the agricultural field 14 and to send signal(s) to a controller of the obstacle detection system 12. The one or more sensors may be any sensors suitable to acquire data indicative of the properties of the agricultural field 14. For example, the sensors may include one or more light detection and ranging (lidar) sensors, radio detection and ranging (radar) sensors, image sensors (e.g., RGB camera sensors, stereo camera sensors, etc.), infrared (IR) sensors, and the like. In the illustrated embodiment, the obstacle detection system 12 includes at least one lidar sensor 20 and at least one radar sensor 22. The lidar sensor 20 and the radar sensor 22 may be coupled to the agricultural vehicle 10 in a front position 24, in a top position 26, or any suitable location to acquire data indicative of the properties of the agricultural field 14. As described in detail below obstacle detection system 12 may include a controller that detects an obstacle 28 via data from the lidar sensor 20 and the radar sensor 22.

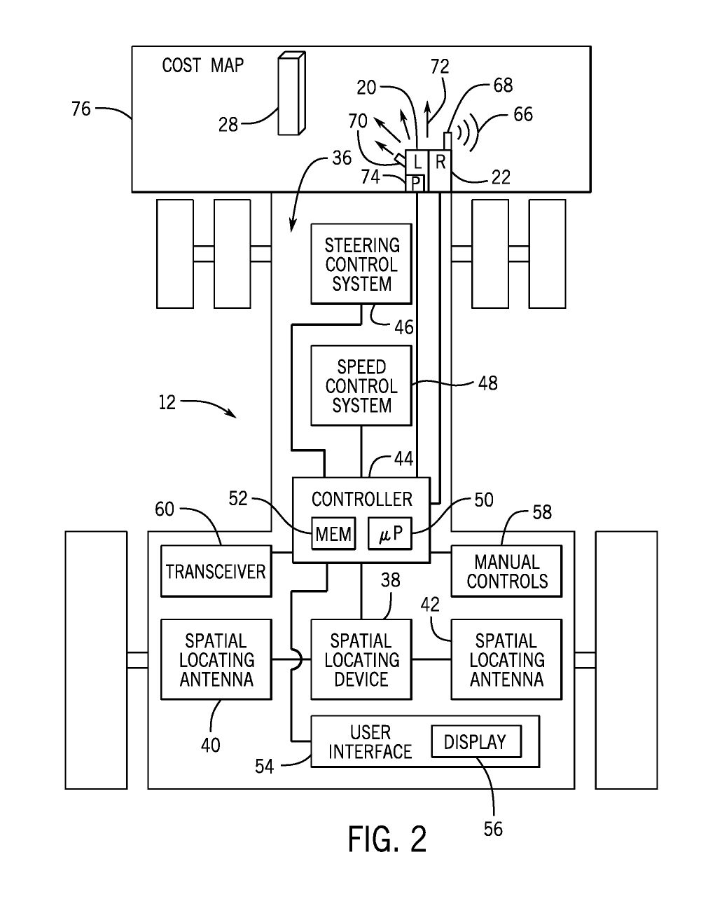

FIG. 2 is a schematic diagram of an embodiment of the obstacle detection system 12 of a control system of the vehicle 10 of FIG. 1. The obstacle detection system 12 may include a spatial locating device 38 mounted to the autonomous agricultural vehicle 10 to determine a position, and in certain embodiments a velocity, of the autonomous agricultural vehicle 10. The obstacle detection system 12 may include one or more spatial locating antennas 40 and 42 communicatively coupled to the spatial locating device 38. Each spatial locating antenna is configured to receive spatial locating signals (e.g., GPS signals from GPS satellites) and to output corresponding spatial locating data to spatial locating device 38. While the illustrated agricultural vehicle 10 includes two spatial locating antennas, it should be appreciated that in alternative embodiments, the control system may include more or fewer spatial locating antennas (e.g., 1, 2, 3, 4, 5, 6, or more).

In certain embodiments, the obstacle detection system 12 of the control system may also include an inertial measurement unit (IMU) communicatively coupled to the controller 44 and configured to enhance the accuracy of the determined position and/or orientation. For example, the IMU may include one or more accelerometers configured to output signal(s) indicative of acceleration along the longitudinal axis, the lateral axis, the vertical axis, or a combination thereof. In addition, the IMU may include one or more gyroscopes configured to output signal(s) indicative of rotation (e.g., rotational angle, rotational velocity, rotational acceleration, etc.) about the longitudinal axis, the lateral axis, the vertical axis, or a combination thereof. The controller may determine the position and/or orientation of the agricultural vehicle based on the IMU signal(s) while the spatial locating signals received by the spatial locating antennas are insufficient to facilitate position determination (e.g., while an obstruction, such as a tree or building, blocks the spatial locating signals from reaching the spatial locating antennas). In addition, the controller 44 may utilize the IMU signal(s) to enhance the accuracy of the determined position and/or orientation. For example, the controller 44 may combine the IMU signal(s) with the spatial locating data and/or the position determined by the spatial locating device (e.g., via Kalman filtering, least squares fitting, etc.) to determine a more accurate position and/or orientation of the agricultural vehicle (e.g., by compensating for movement of the spatial locating antennas resulting from pitch and/or roll of the agricultural vehicle as the agricultural vehicle traverses uneven terrain).

In certain embodiments, the IMU and the spatial locating device may be disposed within a common housing. In further embodiments, the IMU and one spatial locating antenna may be disposed within a common housing. For example, each spatial locating antenna housing may include a spatial locating antenna and an IMU. Furthermore, in certain embodiments, a portion of the spatial locating device and one spatial locating antenna may be disposed within a common housing. For example, a first portion of the spatial locating device and the first spatial locating antenna may be disposed within a first housing, and a second portion of the spatial locating device and the second spatial locating antenna may be disposed within a second housing. In certain embodiments, a first IMU may be disposed within the first housing, and a second IMU may be disposed within the second housing.

In the illustrated embodiment, the obstacle detection system 12 of the control system of the vehicle 10 includes a steering control system 46 configured to control a direction of movement of the autonomous agricultural vehicle 10, and a speed control system 48 configured to control a speed of the autonomous agricultural vehicle 10. In addition, the obstacle detection system 12 includes the controller 44, which is communicatively coupled to the spatial locating device 38, to the steering control system 46, to the speed control system 48, to the lidar sensor 20, and to the radar sensor 22. The controller 44 is configured to automatically control the agricultural vehicle during certain phases of agricultural operations (e.g., without operator input, with limited operator input, etc.). While the controller is shown as controller the object detection system as well as the control systems of the agricultural vehicle, other embodiments may include a controller for the object detection system and a controller 44 for the control systems of the agricultural vehicle.

In certain embodiments, the controller 44 is an electronic controller having electrical circuitry configured to process data from the lidar sensor 20 and the radar sensor 22, as well as the other components of the control system 36. In the illustrated embodiment, the controller 44 includes a processor 50, such as the illustrated microprocessor, and a memory device 52. The controller 44 may also include one or more storage devices and/or other suitable components. The processor 50 may be used to execute software, such as software for controlling the autonomous agricultural vehicle, software for determining vehicle orientation, and so forth. Moreover, the processor 50 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) processors.

The memory device 52 may include a volatile memory, such as random access memory (RAM), and/or a nonvolatile memory, such as read-only memory (ROM). The memory device 52 may store a variety of information and may be used for various purposes. For example, the memory device 52 may store processor-executable instructions (e.g., firmware or software) for the processor 50 to execute, such as instructions for controlling the autonomous agricultural vehicle, instructions for determining vehicle orientation, and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., sensor data, position data, vehicle geometry data, etc.), instructions (e.g., software or firmware for controlling the autonomous agricultural vehicle, etc.), and any other suitable data.

In certain embodiments, the steering control system 46 may include a wheel angle control system, a differential braking system, a torque vectoring system, or a combination thereof. The wheel angle control system may automatically rotate one or more wheels and/or tracks of the autonomous agricultural vehicle (e.g., via hydraulic actuators) to steer the autonomous agricultural vehicle along a desired route (e.g., along the guidance swath, along the swath acquisition path, etc.). By way of example, the wheel angle control system may rotate front wheels/tracks, rear wheels/tracks, and/or intermediate wheels/tracks of the autonomous agricultural vehicle, either individually or in groups. The differential braking system may independently vary the braking force on each lateral side of the autonomous agricultural vehicle to direct the autonomous agricultural vehicle along a path. Similarly, the torque vectoring system may differentially apply torque from an engine to wheels and/or tracks on each lateral side of the autonomous agricultural vehicle, thereby directing the autonomous agricultural vehicle along a path. In further embodiments, the steering control system may include other and/or additional systems to facilitate directing the autonomous agricultural vehicle along a path through the field.

In certain embodiments, the speed control system 48 may include an engine output control system, a transmission control system, a braking control system, or a combination thereof. The engine output control system may vary the output of the engine to control the speed of the autonomous agricultural vehicle. For example, the engine output control system may vary a throttle setting of the engine, a fuel/air mixture of the engine, a timing of the engine, other suitable engine parameters to control engine output, or a combination thereof. In addition, the transmission control system may adjust input-output ratio within a transmission to control the speed of the autonomous agricultural vehicle. Furthermore, the braking control system may adjust braking force, thereby controlling the speed of the autonomous agricultural vehicle. In further embodiments, the speed control system may include other and/or additional systems to facilitate adjusting the speed of the autonomous agricultural vehicle.

In certain embodiments, the controller 44 may also control operation of an agricultural implement coupled to the autonomous agricultural vehicle. For example, the control system may include an implement control system/implement controller configured to control a steering angle of the implement (e.g., via an implement steering control system having a wheel angle control system and/or a differential braking system) and/or a speed of the autonomous agricultural vehicle/implement system (e.g., via an implement speed control system having a braking control system). In such embodiments, the controller 44 may be communicatively coupled to a control system/controller on the implement via a communication network, such as a controller area network (CAN bus).

In the illustrated embodiment, the obstacle detection system 12 includes a user interface 54 communicatively coupled to the controller 44. The user interface 54 is configured to enable an operator (e.g., standing proximate to the autonomous agricultural vehicle) to control certain parameters associated with operation of the autonomous agricultural vehicle. For example, the user interface 54 may include a switch that enables the operator to configure the autonomous agricultural vehicle for autonomous or manual operation. In addition, the user interface 54 may include a battery cut-off switch, an engine ignition switch, a stop button, or a combination thereof, among other controls. In certain embodiments, the user interface 54 includes a display 56 configured to present information to the operator, such as a graphical representation of a guidance swath, a visual representation of certain parameter(s) associated with operation of the autonomous agricultural vehicle (e.g., fuel level, oil pressure, water temperature, etc.), a visual representation of certain parameter(s) associated with operation of an implement coupled to the autonomous agricultural vehicle (e.g., seed level, penetration depth of ground engaging tools, orientation(s)/position(s) of certain components of the implement, etc.), or a combination thereof, among other information. In certain embodiments, the display 56 may include a touch screen interface that enables the operator to control certain parameters associated with operation of the autonomous agricultural vehicle and/or the implement.

In the illustrated embodiment, the control system 36 includes manual controls 58 configured to enable an operator to control the autonomous agricultural vehicle while automatic control is disengaged (e.g., while unloading the autonomous agricultural vehicle from a trailer, etc.). The manual controls 58 may include manual steering control, manual transmission control, manual braking control, or a combination thereof, among other controls. In the illustrated embodiment, the manual controls 58 are communicatively coupled to the controller 44. The controller 44 is configured to disengage automatic control of the autonomous agricultural vehicle upon receiving a signal indicative of manual control of the autonomous agricultural vehicle. Accordingly, if an operator controls the autonomous agricultural vehicle manually, the automatic control terminates, thereby enabling the operator to control the autonomous agricultural vehicle.

In the illustrated embodiment, the agricultural vehicle 10 includes one or more lidar sensors 20 and/or radar sensors 22. While the lidar sensor 20 and the radar sensor 22 of FIG. 2 are shown in a configuration (e.g., lidar to the left of radar sensor), this is simply meant to be an example and any suitable configuration may be used. Each sensor 20 and 22 may detect properties of the environment (e.g., agricultural field 14) and provide data to the controller 44. For example, the radar sensor 22 may send radio waves 66 via an antenna 68 into the environment. The radio waves 66 may then interact with the environment. Some of the radio waves may then be reflected due to the obstacle 28, and the reflected radio waves 66 may be detected by the radar sensor 22 via the antenna 68. Based on a speed at which the radio waves travel and an amount of time between when the radio waves 66 are sent and received, a distance between the obstacle 28 may be determined and the agricultural vehicle 10 may be determined (e.g., via the controller 44 and/or the sensor 22). The radar sensor 22 may send signal(s) to the controller 44 indicative of a distance between the obstacle 28 and the agricultural vehicle 10 (e.g., the determined distance and/or the amount of time between when the radio waves 66 are sent and received).

In the illustrated embodiment, the lidar sensor 20 may include one or more lasers 70. The lidar sensors 20 may send pulses of light 72, such as infrared (IR) light, colored light, or electromagnetic radiation of any suitable frequency, in various directions to interact with the environment. Some of the light 72 may be reflected due to the obstacle 28 and the laser sensor 20 may receive the reflected light (e.g., via the photodiode 74). Based on a speed at which the light 72 travels and an amount of time between when the light 72 is sent and received, a distance between the obstacle 28 and the agricultural vehicle 10 may be determined (e.g., via the controller 44 and/or the sensor 20). The lidar sensor 20 may send signal(s) to the controller indicative of a distance between the obstacle 28 and the agricultural vehicle 10 (e.g., the determined distance and/or the amount of time between when the light 72 is sent and the photodetector 74 detects the light 72). Moreover, depending on the direction that the light 72 is sent, a direction in which the obstacle 28 is detected may be determined.

In certain embodiments, the control system may include other and/or additional controllers/control systems, such as the implement controller/control system discussed above. For example, the implement controller/control system may be configured to control various parameters of an agricultural implement towed by the agricultural vehicle. In certain embodiments, the implement controller/control system may be configured to instruct actuator(s) to adjust a penetration depth of at least one ground engaging tool of the agricultural implement. By way of example, the implement controller/control system may instruct actuator(s) to reduce or increase the penetration depth of each tillage point on a tilling implement, or the implement controller/control system may instruct actuator(s) to engage or disengage each opener disc/blade of a seeding/planting implement from the soil. Furthermore, the implement controller/control system may instruct actuator(s) to transition the agricultural implement between a working position and a transport portion, to adjust a flow rate of product from the agricultural implement, or to adjust a position of a header of the agricultural implement (e.g., a harvester, etc.), among other operations. The agricultural vehicle control system may also include controller(s)/control system(s) for electrohydraulic remote(s), power take-off shaft(s), adjustable hitch(es), or a combination thereof, among other controllers/control systems.

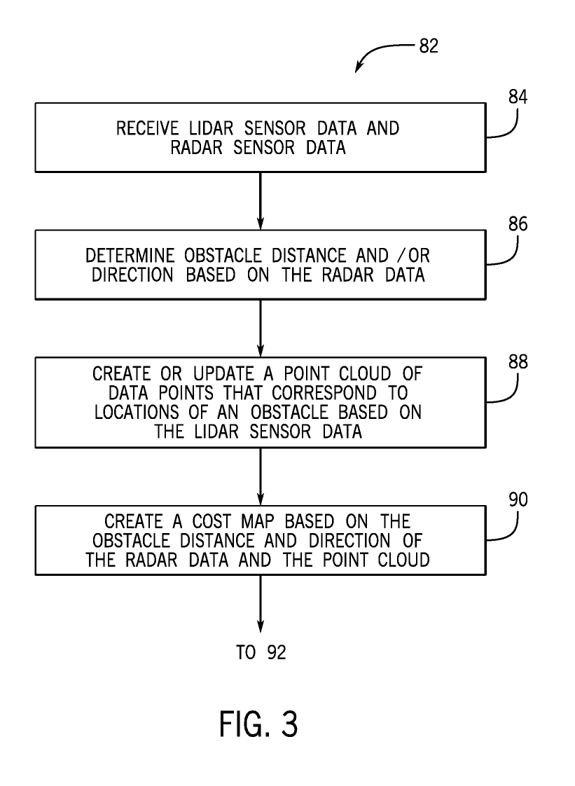

FIG. 3 is a flow diagram of a process 82 performed by the processor 50 to create or update the map 76 of FIG. 2. At block 84, the processor 50 may receive lidar sensor data and radar sensor data. As explained above, while a lidar sensor and a radar sensor are used as an example, any combination of sensors suitable may be used. The controller 44 may receive signal(s) from the lidar sensor 20 indicative of the distances and/or directions from the agricultural vehicle to the obstacle 28. Further, the controller 44 may receive radar sensor data indicating distance to the obstacle 28. At block 86, the processor 50 may determine obstacle distance and/or direction based on the radar data. For example, the processor 50 may determine distance and/or direction of the obstacle 28 based on the amount of time between when the radio wave 66 is sent and when the radio wave 66 is received. The radar sensor 22 may provide the distance to the controller 44

At block 88, the processor 50 may create or update the point cloud having data points that correspond to locations of an obstacle based on the lidar sensor data. While the illustrated embodiment includes lidar sensor data, in other embodiments, the point cloud data may be acquired via a stereo camera. In certain embodiments, the lidar sensor 20 may include multiple lasers 70 to send light 72 in multiple directions. The processor 50 may then create or update a set of points in a coordinate system, referred to as a point cloud, based on the distances and/or directions of the light received by the lidar sensor 20. For example, the processor 50 may determine points in a coordinate system that correspond to the locations from the distances and the direction that the light reflected from the obstacle 28.

At block 90, the processor 50 may create or update a map 76 based on the obstacle distance and direction. The map 76 may be a coordinate (e.g., Cartesian, Polar, etc.) map (e.g., 1 dimension, 2 dimensions, or 3 dimensions) having cells that correspond to locations on a surface of the agricultural field 14 indicating if a particular area includes an obstacle or not (e.g., an occupancy grid). While the obstacle is shown as an object, in some embodiments, the obstacle may include un-drivable terrain (e.g., steep stream bank or burm, etc.) in addition to objects in the environment. Each grid cell may include a state of obstacle or non-obstacle. Further, each grid cell may be independent of one another and have a prior probability indicating a probability that the respective grid cell had an obstacle (e.g., from prior grid cell data). The processor 50 may determine a height difference by calculation of a gradient (e.g., slopes) between the points of the point cloud. If the height difference (e.g., from lasers sent at various heights) in a given cell associated with the point cloud is greater than neighbor cells, then the processor 50 may determine that an obstacle is occupying the location that corresponds to the grid cell. The processor 50 may determine the height difference by calculation of a gradient (e.g., slopes) between the points of the point cloud. The processor 50 may determine that an obstacle is present if the gradient exceeds a threshold. In some embodiments, the grid cells used to analyze the point cloud from the lidar sensors may be different than the grid cells of the map 76. For example, a first grid of points from the point cloud may be used to determine height differences between points of the point cloud in determining whether an obstacle is present or not, and a second grid may be used to indicate locations on the surface of the agricultural field 14 that include obstacles or not. Further, while a gradient of points from a point cloud is used as an example, any suitable method may be used to determine whether an obstacle is present in a grid cell.

The processor 50 may utilize prior data in conjunction with more recent lidar and radar sensor data to determine the state of each grid cell. For example, each sensor may include a true positive rate and a true negative rate. The processor 50 may associate the lidar sensor data with the lidar true positive and true negative rates and the radar sensor data with the radar true positive and true negative rates. The processor 50 may then identify the grid cell of the location associated with the lidar sensor data and the radar sensor data. The processor 50 may determine a probability of an obstacle being present at the location corresponding to the grid cell based on the true positive and true negative rates, the prior grid cell probability of an obstacle occupying the location corresponding to the grid cell, and the lidar and radar sensor data. For example, the processor 50 may determine the probability of the obstacle being present in the grid cell using Bayes theorem to account for prior cell probability, the probability of the true positive and true negative rates, and the lidar and/or radar sensor data. Bayes' theorem may include:

$$P ( A \vert B ) = \frac{P ( B \vert A ) P ( A )}{P ( B )} \qquad ( 1 )$$

where P(A|B) is the probability that the obstacle is present given that the sensor detected the obstacle, P(B|A) is the probability that the sensor detected the obstacle previously, P(A) is the true positive rate (e.g., probability that the sensor is correct), P(B) is the probability of the obstacle being detected.

In some embodiments, the processor 50 may weigh probabilities of different sensors in determining the map, such as weighing the lidar sensor data, radar sensor data, red-blue-green (RGB) sensor data, based on the respective sensor accuracy. The processor 50 may determine whether the grid cell includes an obstacle or does not include an obstacle by comparing the determined probability to a threshold. If the probability of an obstacle is greater than a threshold probability, the grid cell indicates the cell as an obstacle. The data is sent to a control system to control the operations of the vehicle.

In some embodiments, the radar 22 may provide the controller with a distance to the obstacle 28. The processor 50 may determine that the obstacle 28 is located at a distance. The processor 50 may create an arc of obstacle data in a point cloud format based on the distance. The processor 50 may determine that the area within the arc does not include the obstacle 28.

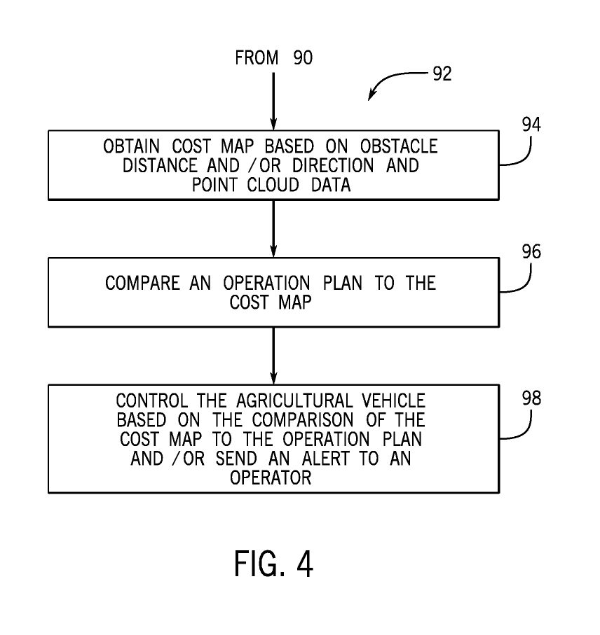

FIG. 4 is a flow diagram of a process 92 performed by the processor 50 to control the vehicle based on the map of FIG. 3. The process 92 may be stored as instructions (e.g., code) in the memory 52 of the agricultural vehicle 10. While the process 92 is described as being performed by the processor 50, this is meant to be an example, and any suitable control system may be used to perform the process 92. At block 94, the processor 50 may obtain a map based on point cloud data from the lidar sensor and the obstacle distance and/or direction from the radar sensor. In certain embodiments, another control system on the agricultural vehicle 10 may include a processor 50 that performs the process 92. The controller 52 may send signal(s) to the other control system to perform the process 92. In some embodiments, the controller 52 may transmit signal(s) via the transceiver 60 to another control system not located on the agricultural vehicle 10. The other control system may include another controller that performs the process 92 and sends signals to the controller 52 indicative of instructions to enable the controller 52 to control the steering control system 46 and/or speed control system 48.

At block 96, the processor 50 may compare an operation plan to the map 72 to determine if the current plan is blocked by the detected obstacle on the map 72. That is, if the lidar sensor 20 and/or radar sensor 22 detects an obstacle, the obstacle may be located on the map. The processor 50 may create a drivable path plan that travels around the detected obstacle based on the location of the obstacle in the map 72.

At block 98, the processor 50 may send signal(s) to control the agricultural vehicle 10 based on the comparison of the map to the operation plan and/or send an alert to an operator. In certain embodiments, the processor 50 may drive the drivable path plan without input from an operator. In other embodiments, the processor 50 may send the drivable path plan to an operator of a control system to enable the operator to accept or reject the proposed path travel around the obstacle. In some embodiments, the processor 50 my send a set of drivable path plans to enable an operator to select from. For example, the processor 50 may receive a selected drivable path plan and control the vehicle based on the selected plan. The processor 50 may receive a path plotted by the operator and control the vehicle to travel along the plotted path. Further, an operator may view images from an RGB camera on the agricultural vehicle to identify the obstacle and determine whether the obstacle is a drivable obstacle, such as a weed, or a non-drivable obstacle, such as a fence. In some embodiments, the processor 50 may control the agricultural vehicle 10 by sending a signal to stop the agricultural vehicle 10 and wait for feedback from the operator. By controlling the agricultural vehicle 10 in a path that travels around the obstacle, the agricultural vehicle 10 may continue to perform the agricultural operation with reduced operator input while still avoiding contacting non-drivable obstacles.

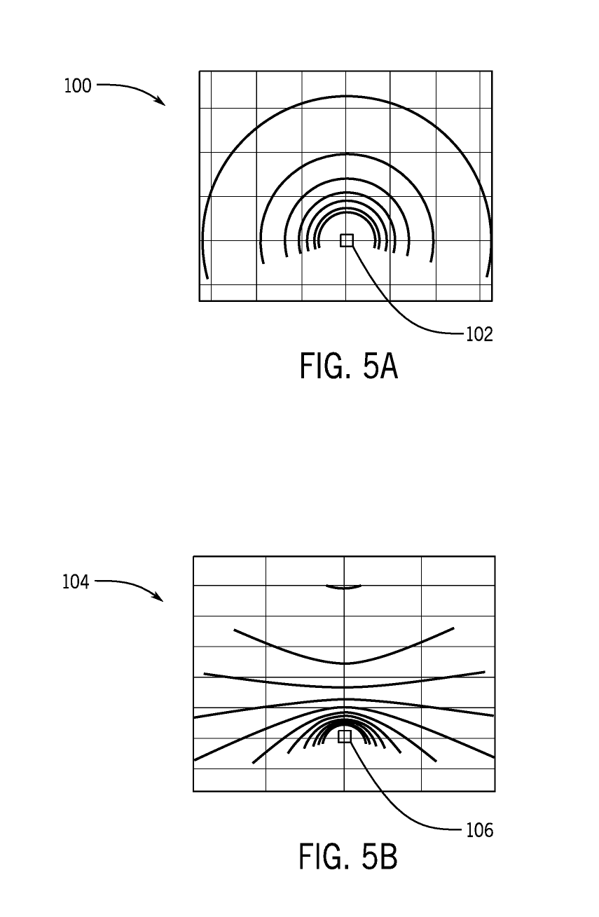

Depending on the sensor, positioning of the sensor may enable the sensor to acquire additional data. FIG. 5A and FIG. 5B show graphs 100 and 104 of a scanning pattern of data acquired by the lidar detector 20. The boxes 102 and 106 on each of FIGS. 5A and 5B are the approximate vehicle dimensions. Depending on the sensor, some lidar sensors 20 may include a field of view of −15 to 15 degrees from level. Graph 100 shows the scanning pattern acquired by the lidar detector 20 in a level position with respect to the agricultural field 14. Graph 104 shows the scanning pattern acquired by the lidar detector 20 in a position angled towards the ground. That is, the lidar sensor may be positioned in a downward (e.g., 5-10 degrees) direction to provide a greater resolution of scanning patterns detected by the lidar detector 20 by utilizing a larger percentage of the field of view of the lidar sensor 20 as compared to a lidar sensor 20 positioned level to the agricultural field 14.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A work vehicle, comprising:
at least one sensor configured to detect at least one property of a work area; and
a controller comprising a processor operatively coupled to a memory, wherein the controller is configured to receive a first signal from at least one sensor indicative of the at least one property of the work area, to determine whether an obstacle occupies one or more locations on a two dimensional (2D) surface of the work area by creating or updating a map having a plurality of cells that cover the 2D surface of the work area, one or more cells of the plurality of cells correspond to the locations on the 2D surface of the work area, wherein each cell of the plurality of cells indicates whether the obstacle occupies the cell based on the at least one property, and to output a second signal based on the map.

2. The vehicle of claim 1, wherein the controller is configured to output a third signal indicative of instructions to control the vehicle based on the map.

3. The vehicle of claim 1, wherein the controller is configured to output a fourth signal to a user interface to alert an operator of the obstacle.

4. The vehicle of claim 1, wherein the controller is configured to determine a probability of the obstacle occupying the one or more locations by using Bayes' Theorem in which the probability is based on the true positive and true negative rates, prior grid cell probability of an obstacle occupying the one or more locations, and lidar and radar sensor data.

5. The vehicle of claim 1, wherein the controller is configured to determine whether the obstacle occupies the one or more locations by comparing a probability of the obstacle occupying the one or more locations to a threshold probability.

6. The vehicle of claim 1, wherein the at least one sensor comprises a lidar sensor configured to output the first signal indicative of a distance and a direction of the obstacle based on light reflecting from the obstacle.

7. The vehicle of claim 6, wherein the controller is configured to create or update a point cloud of each distance and direction from the light reflecting from the obstacle to be used in creating or updating the map.

8. A work vehicle, comprising:
a lidar sensor; and
a controller comprising a processor and a memory, wherein the controller is configured to receive a first signal from the lidar sensor indicating distances and directions to an obstacle in a work area, to create or update a point cloud having a set of points based on the distance and directions, to create or update a map of a plurality of cells that cover a two dimensional (2D) surface of the work area, one or more cells of the plurality of cells correspond to one or more locations on the 2D surface of the work area, wherein each cell of the plurality of cells indicate whether the obstacle occupies the cell based on the points of the point cloud, to output a second signal indicative of the map to a control system of the vehicle.

9. The vehicle of claim 8, wherein the lidar sensor and radar sensor are mounted to a front of the vehicle.

10. The vehicle of claim 8, wherein the lidar sensor is positioned in a downward direction toward the work area to provide a greater resolution of scanning patterns detected by the lidar detector by utilizing a larger percentage of the field of view of the lidar sensor as compared to a lidar sensor positioned level to the work area.

11. The vehicle of claim 10, wherein the lidar sensor is positioned at an angle positioned aiming downward in the range of zero to fifteen degrees below level.

12. The vehicle of claim 8, comprising a radar sensor, wherein the controller is configured to determine the map by weighing probabilities of presence of the object based on radar sensor data and lidar sensor data according to the radar sensor accuracy and the lidar sensor accuracy.

13. The vehicle of claim 8, wherein the controller is configured to create or update the map based at least in part on a prior probability of presence of the obstacle in each cell.

14. A control system for a work vehicle, comprising:
a controller comprising a processor and a memory, wherein the memory is operatively coupled to the processor, wherein the processor is configured to receive a first signal from a first sensor indicating distances and directions to an obstacle in an agricultural field, to create or update a map of a plurality of cells that cover a two dimensional (2D) surface of the agricultural field, each cell of the plurality of cells corresponding to one or more locations on the 2D surface of the agricultural field, wherein each cell of the plurality of cells indicate whether the obstacle occupies the respective locations of the agricultural field, and to output a second signal indicative of instructions to control the vehicle based on the map.

15. The control system of claim 14, wherein the controller is configured to send the second signal indicative of instructions to control the vehicle based on the map.

16. The control system of claim 14, wherein the controller is configured to stop the vehicle to await further instructions from an operator.

17. The control system of claim 14, wherein the controller is configured to create or update a point cloud of points based on the distances and directions of light reflecting on the obstacle to be used in creating or updating the map.

18. The control system of claim 14, wherein the controller is configured to create or update the map based at least in part on a prior probability of presence of the obstacle in each cell.

19. The control system of claim 14, wherein the controller is configured to determine a probability of the obstacle occupying the one or more locations by using Bayes' Theorem in which the probability is based on the true positive and true negative rates, prior grid cell probability of an obstacle occupying the one or more locations, and the Lidar and Radar sensor data.

20. The control system of claim 14, wherein the controller is configured to determine whether the obstacle occupies the one or more locations by comparing a probability of the obstacle occupying the one or more locations to a threshold probability.
